(19) United States
(12) Patent Application Publication
(10) Pub. No.: US 2025/0123197 A1
(43) Pub. Date: Apr. 17, 2025

(54) TEMPERATURE MEASUREMENT OF CARBON COATED TRIBOLOGICAL TESTING APPARATUS

(71) Applicant: ExxonMobil Technology and Engineering Company, Spring, TX (US)

(72) Inventors: Weixue TIAN, Short Hills, NJ (US); Spyridon KORRES, Hamburg (DE); Pinzhi LIU, Berkeley Heights, NJ (US); Jordan SMITH, Spring, TX (US); Shuji LUO, Basking Ridge, NJ (US)

(73) Assignee: ExxonMobil Technology and Engineering Company, Spring, TX (US)

(21) Appl. No.: 18/916,454

(22) Filed: Oct. 15, 2024

Related U.S. Application Data
(60) Provisional application No. 63/590,947, filed on Oct. 17, 2023.

(51) Int. Cl. G01N 19/02

(52) U.S. Cl. CPC G01N 19/02

(57) ABSTRACT

Thermal imaging may be used for obtaining measurements of a tribological testing apparatus including a contact temperature. For example a method of calculating a contact temperature may include: introducing a testing sample into a contact zone of a tribological testing apparatus; engaging a testing operation of the tribological testing apparatus; measuring a contact emission of a testing surface of the tribological testing apparatus with an infrared camera; and calculating a contact temperature of the testing sample in the contact zone from the contact emission; wherein the tribological testing apparatus has a carbon coating on the testing surface of the contact zone, wherein the carbon coating has a first infrared emissivity, wherein the testing sample has a second infrared emissivity, and wherein the first infrared emissivity is within +/−20% of the second infrared emissivity.

### FIELD OF INVENTION

This application relates to tribological testing methods.

### BACKGROUND

Tribological testing (or tribo-testing) includes methods and systems for testing friction, wear, fatigue life and other similar properties of lubricants and lubricated products. Conventional tribological testing methods and systems may utilize various testing apparatus whereby surfaces are contacted in the presence of a lubricant and measured values may be obtained.

Conventional tribological testing systems may include a mini traction machine (MTM), a micro pitting rig (MPR), a twin disk machine, or the like. Such systems measure metrics such as friction through movement of multiple components in contact in the presence of a lubricant sample to be tested. Various geometry of tribological testing systems may allow for testing lubricant samples in various environments prior to field application.

### SUMMARY OF INVENTION

A first nonlimiting example method of the present disclosure may include: introducing a testing sample into a contact zone of a tribological testing apparatus; engaging a testing operation of the tribological testing apparatus; measuring a contact emission of a testing surface of the tribological testing apparatus with an infrared camera; and calculating a contact temperature of the testing sample in the contact zone from the contact emission; wherein the tribological testing apparatus has a carbon coating on the testing surface of the contact zone, wherein the carbon coating has a first infrared emissivity, wherein the testing sample has a second infrared emissivity, and wherein the first infrared emissivity is within +/−20% of the second infrared emissivity.

A second nonlimiting example method of the present disclosure may include: introducing a testing sample comprising a lubricant into a contact zone of a tribological testing apparatus; engaging a testing operation of the tribological testing apparatus; measuring a contact emission of a testing surface of the tribological testing apparatus with an infrared camera; and calculating a contact temperature of the testing sample in the contact zone from the contact emission; wherein the tribological testing apparatus has a carbon coating on the testing surface of the contact zone, wherein the carbon coating has a first infrared emissivity, wherein the first infrared emissivity is from about 0.8 to about 1.0, wherein the testing sample has a second infrared emissivity, and wherein the first infrared emissivity is within +/−20% of the second infrared emissivity.

A third nonlimiting example method of the present disclosure may include: applying a carbon coating to a testing surface of a contact zone of a tribological testing apparatus, wherein the carbon coating has a first infrared emissivity, wherein the first infrared emissivity is from about 0.8 to about 1.0; introducing a lubricant into the contact zone of the tribological testing apparatus, wherein the lubricant has a second infrared emissivity, and wherein the first infrared emissivity is within +/−20% of the second infrared emissivity; measuring a contact emission of the testing surface of the tribological testing apparatus with an infrared camera, wherein the testing surface is heated by a testing operation of the tribological testing apparatus; and calculating a contact temperature of the lubricant in the contact zone from the contact emission.

These and other features and attributes of the disclosed methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram of a nonlimiting example system according to the present disclosure.

FIG. 2 is a diagram of a nonlimiting example portion of a tribological testing apparatus according to the present disclosure.

FIG. 3 is a diagram of an example computer system that can be employed to execute one or more embodiments of the present disclosure.

FIG. 4 is an infrared image of a comparative example according to the present disclosure.

FIG. 5 is an infrared image of a comparative example according to the present disclosure.

FIG. 6 is an infrared image of an example according to the present disclosure.

FIGS. 7A-7B are infrared images of an example according to the present disclosure.

### DETAILED DESCRIPTION

This application relates to tribological testing methods.

Methods of the present disclosure may include use of a carbon coating on a tribological testing apparatus during a testing operation such that a contact temperature within the testing apparatus can be measured using an infrared camera with increased consistency and increased accuracy.

Methods of the present disclosure may include introducing a testing sample into a contact zone of a tribological testing apparatus during a testing operation, and based on infrared emission of the contact surface, a contact temperature of the testing sample in the contact zone. Lubricant performance is generally correlated with temperature, thus the need to measure temperature of a lubricant when friction is introduced. Accurate and precise measurement of contact temperature for a tribological testing apparatus may allow for further calculation of additional metrics related to temperature, enabling additional data collection from testing of a sample (e.g., a lubricant).

In general, a tribological testing apparatus may measure tribological metrics (e.g., friction, the like) through movement of multiple components in contact in the presence of a testing sample (e.g., lubricant), thus measuring various metrics of the testing samples. During a testing operation, movement of components in the tribological testing apparatus may generate heat due to friction. Methods of the present disclosure allow for quantification of such heat through accurate and precise temperature measurement using contact emission measurement through infrared radiation.

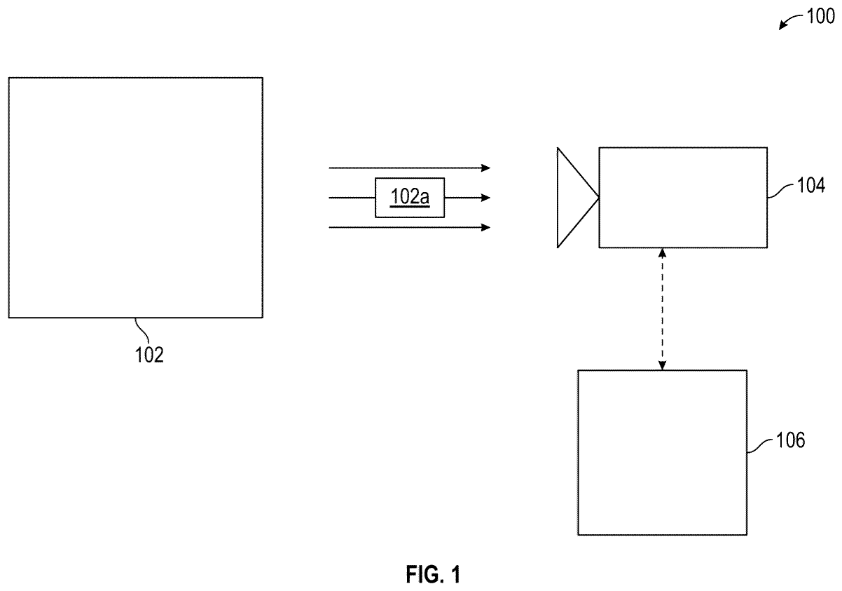

A nonlimiting example system for implementation of the method may be shown in a diagram in FIG. 1. System 100 may include tribological testing apparatus 102 having a carbon coating testing surface therein. Tribological testing apparatus 102 may be in view of infrared camera 104, which may receive infrared radiation 102a from the tribological testing apparatus 102. Infrared camera 104 may be connected to a computer 106 for use in calculation and process. It should be noted that computer 106 may be embedded within infrared camera 104.

Infrared camera devices applicable to the present disclosure may include any suitable infrared imaging devices with a resolution capable of discerning individual components of the tribological testing apparatus so as to measure a contact emission and compute a contact temperature. Infrared camera devices of the present disclosure may include an emissivity baseline setting, allowing filtering of infrared radiation below a certain emissivity, and allowing reduction in noise. Such an emissivity baseline may be set at about 0.9 or greater, or about 0.9 to about 1.0, or about 0.95 to about 1.00, or 0.9 or greater, or 0.9 to 1.0, or 0.95 to 1.00. Furthermore, infrared camera devices applicable to the present disclosure may have any suitable temperature range for measuring contact temperature of tribological testing apparatus of the present disclosure. As an example, a temperature range of infrared cameras applicable to the present disclosure may include, but is not limited to, about 5° C. to about 500° C., or about 10° C. to about 400°° C., or greater than about 500° C.

Calculating a contact temperature of the testing sample in the contact zone from the contact emission may be conducted using any suitable calculation. Without being bound by theory, a quantity of infrared light emitted, frequency of the infrared light, contact emission, or any combination thereof may be used in calculation of a contact temperature. Calculating a contact temperature may be performed by a computer or other such device, including, for example, an integrated computer of the infrared camera. One of ordinary skill in the art will be able to appropriately select and implement use of an infrared camera for obtaining a contact emission and calculating a contact temperature.

Such consistent and accurate contact emission measurement may be supported by carbon coatings within a testing zone of a tribological testing apparatus of the present disclosure. Carbon coatings of the present disclosure may be located on a testing surface of the contact zone within the tribological testing apparatus. “Testing surface,” and grammatical variations thereof, as used herein, refers to a region of the tribological testing apparatus where a testing sample may be placed for testing; a testing surface may include areas of direct contact between components of the tribological testing apparatus as well as surrounding material thermally affected by testing operations.

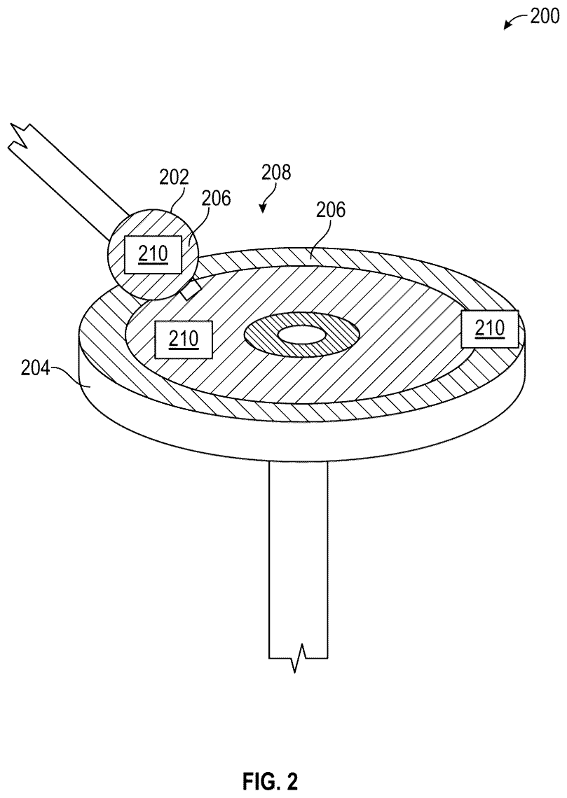

A nonlimiting example portion of a tribological testing apparatus is shown in a diagram FIG. 2. Tribological testing apparatus 200 may include a ball 202 on a disk 204. A testing surface 206 may be located within a contact zone 208 on a surface of the disk 204 and on a surface of ball 202. The testing surface 206 may have thereupon a carbon coating 210, according to the present disclosure.

Carbon coatings of the present disclosure may include any suitable carbon-based coating. Carbon coatings of the present disclosure may comprise from about 50 wt % to about 100 wt % (or about 50 wt % to about 99 wt %, or about 50 wt % to about 90 wt %, or about 60 wt % to about 90 wt %, or about 70 wt % to about 100 wt %, or about 60 wt % to about 80 wt %, or about 75 wt % to about 95 wt %) carbon. Examples of suitable carbon-based coatings may include, but are not limited to, a diamond-like carbon coating, the like, or any combination thereof.

Suitable carbon coatings may have an infrared emissivity (e.g., a first infrared emissivity) near to the infrared emissivity of the testing sample (e.g., a second infrared emissivity), including for example, wherein the infrared emissivity of the carbon coating (e.g., a first infrared emissivity) is within +/−20% (or +/−30%, or +/−10%) of the infrared emissivity of the testing sample (e.g., a second infrared emissivity). Furthermore, suitable carbon coatings may have an infrared emissivity (e.g., a first infrared emissivity) of about 0.8 or greater, or about 0.8 to about 1.0, or about 0.9 or greater, or about 0.9 to about 1.0, or about 0.95 to about 1.00, or 0.9 or greater, or 0.9 to 1.0, or 0.95 to 1.00.

The carbon coating, as applied to the testing surface, may have an average thickness from about 0.2 microns to about 20 microns (or about 0.2 microns to about 15 microns, or about 0.5 microns to about 20 microns, or about 1 microns to about 20 microns, or about 1 microns to about 15 microns, or about 10 microns to about 20 microns, or about 5 microns to about 10 microns, or about 0.2 microns to about 3 microns, or about 0.5 microns to about 2 microns). Furthermore, the carbon coating may have a root mean square surface roughness from 0.005 microns to 2 microns (or about 0.005 microns to about 1.5 microns, or about 0.01 microns to about 2 microns, or about 0.05 microns to about 2 microns, or about 0.1 microns to about 2 microns, or about 0.1 microns to about 1 microns).

Furthermore, the carbon coating may have increased durability over conventional carbon coatings as well as conventional high-emissivity coatings. Carbon coating of the present disclosure may be substantially intact after 20 instances or greater (or 10 instances to 30 instances, or 10 instances or greater, or 30 instances or greater) of a testing operation. “Substantially intact” as used herein refers to a coating that maintains no optically visible flaking, delamination, or wear.

Such carbon coatings may be applied to a testing surface of a contact zone using any suitable means. Examples of application methods of carbon coatings may include, but are not limited to, spray coating, deposition coating, painting, physical vapor deposition, the like, or any combination thereof.

It should be noted that tribological testing apparatuses applicable to the present disclosure may include any suitable tribological testing apparatus where optical access is available such that an infrared camera may be used for thermal measurement. Examples of suitable tribological testing apparatuses may include, but are not limited to, a mini traction machine (MTM) (e.g., a ball-on-disk contact apparatus), a micro pitting rig (MPR), a twin disk machine, the like, or any combination thereof. Carbon coatings may be applied to testing surfaces of any suitable tribological testing apparatus wherein heat due to friction may be generated. One of ordinary skill in the art will be able to apply methods described herein to various tribological apparatuses with the benefit of the present disclosure.

Furthermore, it should be noted the present disclosure may be applicable to testing any suitable testing samples (e.g., lubricants) in a tribological testing apparatus, provided that the lubricants are compatible with the tribological testing apparatus in question and have infrared emissivity compatible with carbon coatings and associated systems as described above herein. Examples of suitable lubricants may include, but are not limited to, automotive lubricants, greases, polymer lubricants, the like, or any combination thereof.

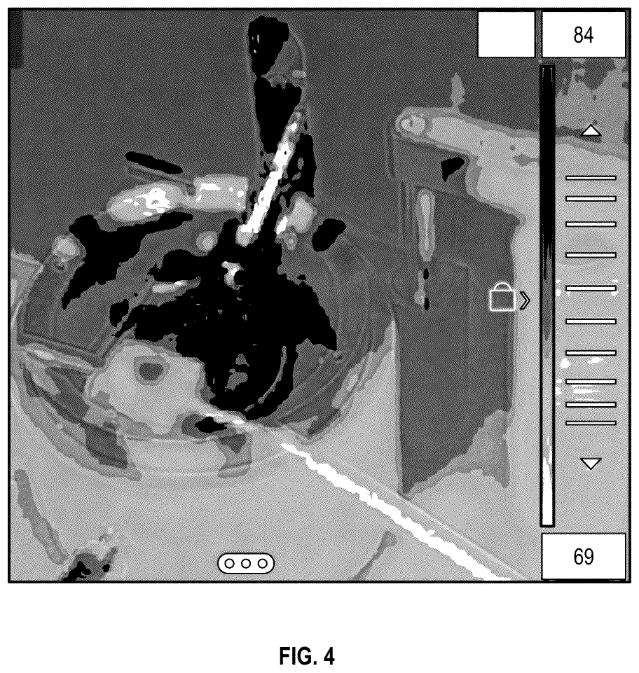

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

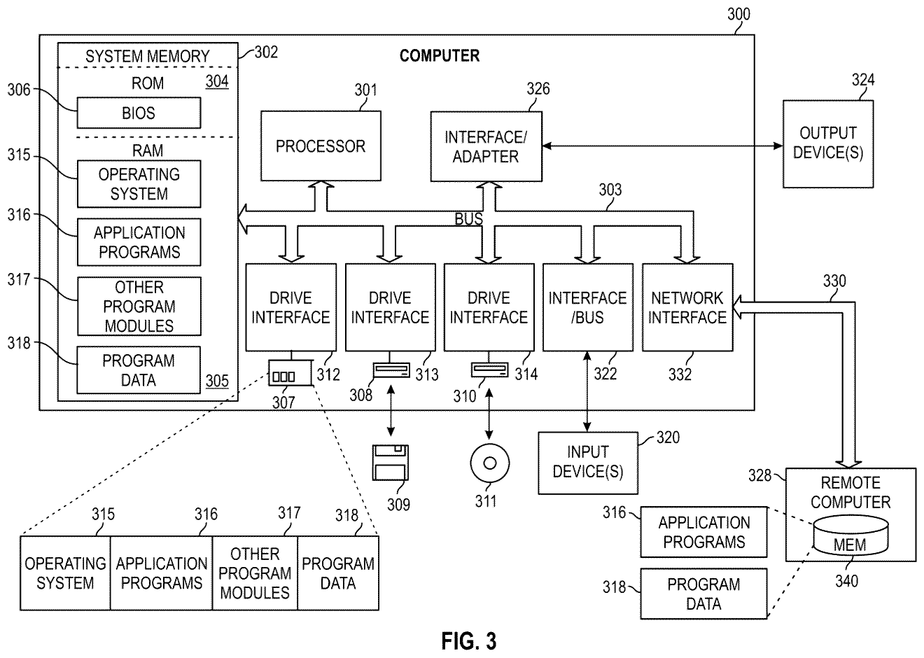

In this regard, FIG. 3 illustrates one example of a computer system 300 that can be employed to execute one or more embodiments of the present disclosure. For example, server 300 may be implemented on computer system 300 in one embodiment. Computer system 300 can be implemented on one or more general purpose networked computer systems, embedded computer systems, routers, switches, server devices, client devices, various intermediate devices/nodes or standalone computer systems. Additionally, computer system 300 can be implemented on various mobile clients such as, for example, a personal digital assistant (PDA), laptop computer, pager, and the like, provided it includes sufficient processing capabilities.

Computer system 300 includes processing unit 302, system memory 304, and system bus 306 that couples various system components, including the system memory 304, to processing unit 302. System memory 304 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 302. System bus 306 may be any of several types of bus structure including a memory bus or memory controller, a peripheral bus, and a local bus using any of a variety of bus architectures. System memory 304 includes read only memory (ROM) 310 and random access memory (RAM) 312. A basic input/output system (BIOS) 314 can reside in ROM 310 containing the basic routines that help to transfer information among elements within computer system 300.

Computer system 300 can include a hard disk drive 316, magnetic disk drive 318, e.g., to read from or write to removable disk 320, and an optical disk drive 322, e.g., for reading CD-ROM disk 324 or to read from or write to other optical media. Hard disk drive 316, magnetic disk drive 318, and optical disk drive 322 are connected to system bus 306 by a hard disk drive interface 326, a magnetic disk drive interface 328, and an optical drive interface 330, respectively. The drives and associated computer-readable media provide nonvolatile storage of data, data structures, and computer-executable instructions for computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 312, including operating system 332, one or more application programs 334, other program modules 336, and program data 338. In some examples, the application programs 334 can include calculation of contact temperature, and the like. In some examples, the program data 338 can include contact emission, and the like. The application programs 334 and program data 338 can include functions and methods programmed to measure contact emission and perform calculations and methods to calculate contact temperature, such as shown and described herein.

A user may enter commands and information into computer system 300 through one or more input devices 340, such as a pointing device (e.g., a mouse, touch screen), keyboard, microphone, joystick, game pad, scanner, and the like. These and other input devices 340 are often connected to processing unit 302 through a corresponding port interface 322 that is coupled to the system bus, but may be connected by other interfaces, such as a parallel port, serial port, or universal serial bus (USB). One or more output devices 324 (e.g., display, a monitor, printer, projector, or other type of displaying device) is also connected to system bus 306 via interface 346, such as a video adapter.

Computer system 300 may operate in a networked environment using logical connections to one or more remote computers, such as remote computer 348. Remote computer 348 may be a workstation, computer system, router, peer device, or other common network node, and typically includes many or all the elements described relative to computer system 300. The logical connections, schematically indicated at 350, can include a local area network (LAN) and/or a wide area network (WAN), or a combination of these, and can be in a cloud-type architecture, for example, configured as private clouds, public clouds, hybrid clouds, and multi-clouds. When used in a LAN networking environment, computer system 300 can be connected to the local network through a network interface or adapter 352. When used in a WAN networking environment, computer system 300 can include a modem, or can be connected to a communications server on the LAN. The modem, which may be internal or external, can be connected to system bus 306 via an appropriate port interface. In a networked environment, application programs 334 or program data 338 depicted relative to computer system 300, or portions thereof, may be stored in a remote memory storage device 354.

### ADDITIONAL EMBODIMENTS

Embodiment 1. A method comprising: introducing a testing sample into a contact zone of a tribological testing apparatus; engaging a testing operation of the tribological testing apparatus; measuring a contact emission of a testing surface of the tribological testing apparatus with an infrared camera; and calculating a contact temperature of the testing sample in the contact zone from the contact emission; wherein the tribological testing apparatus has a carbon coating on the testing surface of the contact zone, wherein the carbon coating has a first infrared emissivity, wherein the testing sample has a second infrared emissivity, and wherein the first infrared emissivity is within +/−20% of the second infrared emissivity.

Embodiment 2. The method of Embodiment 1, further comprising applying the carbon coating to the testing surface of the contact zone, wherein the applying occurs prior to introducing the testing sample.

Embodiment 3. The method of Embodiment 2, wherein applying the carbon coating comprises physical vapor deposition.

Embodiment 4. The method of any one of Embodiments 1-3, wherein the carbon coating comprises about 50 wt % to about 100 wt % carbon.

Embodiment 5. The method of any one of Embodiments 1-4, wherein the first infrared emissivity is from about 0.8 to about 1.0.

Embodiment 6. The method of any one of Embodiments 1-5, wherein the first infrared emissivity is from about 0.95 to about 1.00.

Embodiment 7. The method of any one of Embodiments 1-6, wherein the carbon coating has an average thickness from about 0.2 microns to about 20 microns.

Embodiment 8. The method of any one of Embodiments 1-7, wherein the carbon coating has a root mean square surface roughness from about 0.005 microns to about 2 microns.

Embodiment 9. The method of any one of Embodiments 1-8, wherein the carbon coating remains substantially intact after 20 instances or greater of the testing operation.

Embodiment 10. The method of any one of Embodiments 1-9, wherein the testing sample comprises a lubricant.

Embodiment 11. The method of any one of Embodiments 1-10, wherein the contact zone comprises a ball-on-disk contact.

Embodiment 12. The method of any one of Embodiments 1-11, wherein the tribological testing apparatus comprises a mini traction machine.

Embodiment 13. The method of any one of Embodiments 1-10, wherein the tribological testing apparatus comprises a micro pitting rig or a twin disk.

Embodiment 14. The method of any one of Embodiments 1-13, wherein the infrared camera has an emissivity baseline setting of 0.9 to 1.0.

Embodiment 15. A method comprising: introducing a testing sample comprising a lubricant into a contact zone of a tribological testing apparatus; engaging a testing operation of the tribological testing apparatus; measuring a contact emission of a testing surface of the tribological testing apparatus with an infrared camera; and calculating a contact temperature of the testing sample in the contact zone from the contact emission; wherein the tribological testing apparatus has a carbon coating on the testing surface of the contact zone, wherein the carbon coating has a first infrared emissivity, wherein the first infrared emissivity is from about 0.8 to about 1.0, wherein the testing sample has a second infrared emissivity, and wherein the first infrared emissivity is within +/−20% of the second infrared emissivity.

Embodiment 16. A method comprising: applying a carbon coating to a testing surface of a contact zone of a tribological testing apparatus, wherein the carbon coating has a first infrared emissivity, wherein the first infrared emissivity is from about 0.8 to about 1.0; introducing a lubricant into the contact zone of the tribological testing apparatus, wherein the lubricant has a second infrared emissivity, and wherein the first infrared emissivity is within +/−20% of the second infrared emissivity; measuring a contact emission of the testing surface of the tribological testing apparatus with an infrared camera, wherein the testing surface is heated by a testing operation of the tribological testing apparatus; and calculating a contact temperature of the lubricant in the contact zone from the contact emission.

Embodiment 17. The method of Embodiment 16, wherein the carbon coating comprises about 50 wt % to about 100 wt % carbon.

Embodiment 18. The method of any one of Embodiments 16-17, wherein the infrared camera has an emissivity baseline setting of 0.9 to 1.0

To facilitate a better understanding of the embodiments of the present invention, the following examples of preferred or representative embodiments are given. In no way should the following examples be read to limit, or to define, the scope of the invention.

### EXAMPLES

### Example 1

A sample lubricant A1 was tested in a Mini Traction Machine (MTM) with Hertzian pressure of 1.25 Gigapascal (GPa) and 100% sliding to rolling ratio with entrainment speed of 2 meters per second (m/s). The surface of the MTM had no added coating added. The ball and disk of the MTM were made of 52100 bearing steel with a polished surface. Infrared imaging showed significant data noise in temperature readings of the outer surface of the MTM, as shown in FIG. 4.

### Example 2

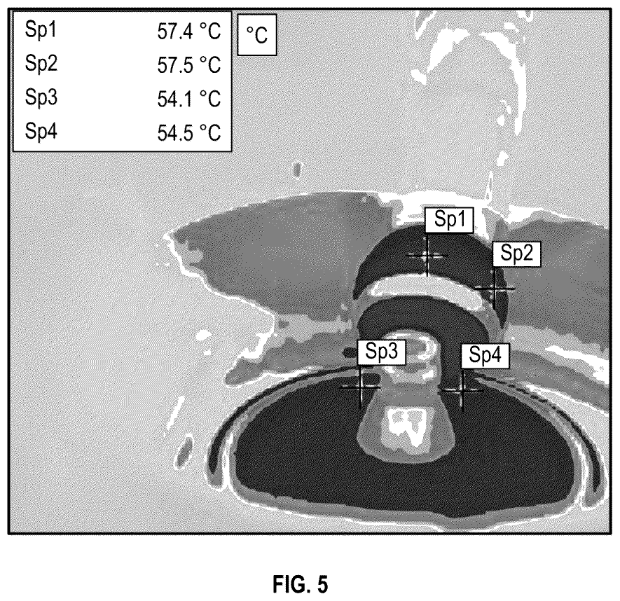

Sample lubricant A1 was tested in the MTM of Example 1 with like testing procedures; however, a high emissivity black coating was applied to the testing surface prior to testing. Immediately upon initiating the testing procedure, beginning motion between ball and disk, the black coating rubbed off at the track of contact, exposing lower emissivity polished steel surface under the coating. As a result, infrared imaging showed data variation in temperature readings and lack of consistency between regions of measurement, as shown in FIG. 5.

### Example 3

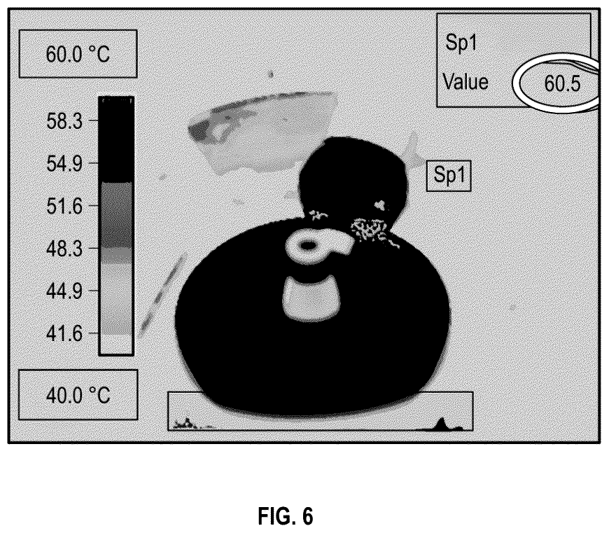

Sample lubricant A1 was tested in the MTM of Example 1 with like testing procedures; however, a high emissivity, high durability carbon coating IE1 comprising a diamond-like carbon coating including a high concentration of amorphous carbon (e.g., Balinite C Deep Black, Balinite DLC Deep Black) was applied to the testing surface prior to testing. Infrared imaging showed data consistency among measurements: the outlet of the contact zone showed highest temperature in the measurement area, and approximately uniform temperature on the steel test specimen due to the high thermal conductivity. The test steel and ball temperatures were shown to be significantly higher than ambient parts. Results from testing Example 3 are shown in FIG. 6.

### Example 4

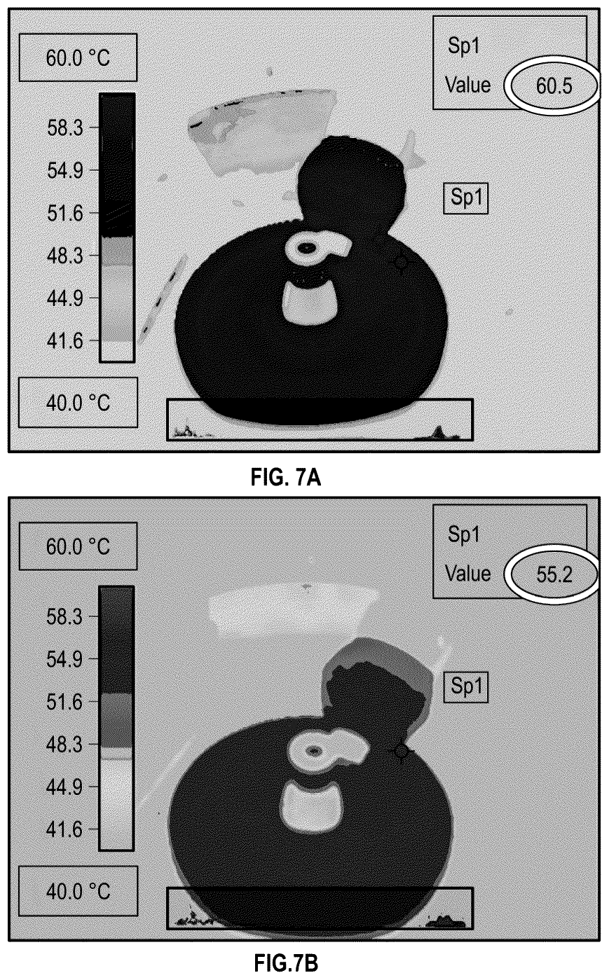

Sample lubricants B1 (MOBILGEAR™ 600 XP 320, available from ExxonMobil) and B2 (PAO ISO VG320, available from ExxonMobil) were tested in the MTM of Example 3 (including coating IE1) with like testing procedures. Infrared imaging showed different but individually consistent temperature data, as shown in FIGS. 7A and 7B.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

What is claimed is:

1. A method comprising:
introducing a testing sample into a contact zone of a tribological testing apparatus;
engaging a testing operation of the tribological testing apparatus;
measuring a contact emission of a testing surface of the tribological testing apparatus with an infrared camera; and
calculating a contact temperature of the testing sample in the contact zone from the contact emission;
wherein the tribological testing apparatus has a carbon coating on the testing surface of the contact zone, wherein the carbon coating has a first infrared emissivity, wherein the testing sample has a second infrared emissivity, and wherein the first infrared emissivity is within +/−20% of the second infrared emissivity.

2. The method of claim 1, further comprising applying the carbon coating to the testing surface of the contact zone, wherein the applying occurs prior to introducing the testing sample.

3. The method of claim 2, wherein applying the carbon coating comprises physical vapor deposition.

4. The method of claim 1, wherein the carbon coating comprises about 50 wt % to about 100 wt % carbon.

5. The method of claim 1, wherein the first infrared emissivity is from about 0.8 to about 1.0.

6. The method of claim 1, wherein the first infrared emissivity is from about 0.95 to about 1.00.

7. The method of claim 1, wherein the carbon coating has an average thickness from about 0.2 microns to about 20 microns.

8. The method of claim 1, wherein the carbon coating has a root mean square surface roughness from about 0.005 microns to about 2 microns.

9. The method of claim 1, wherein the carbon coating remains substantially intact after 20 instances or greater of the testing operation.

10. The method of claim 1, wherein the testing sample comprises a lubricant.

11. The method of claim 1, wherein the contact zone comprises a ball-on-disk contact.

12. The method of claim 1, wherein the tribological testing apparatus comprises a mini traction machine.

13. The method of claim 1, wherein the tribological testing apparatus comprises a micro pitting rig or a twin disk.

14. The method of claim 1, wherein the infrared camera has an emissivity baseline setting of 0.9 to 1.0.

15. A method comprising:
introducing a testing sample comprising a lubricant into a contact zone of a tribological testing apparatus;
engaging a testing operation of the tribological testing apparatus;
measuring a contact emission of a testing surface of the tribological testing apparatus with an infrared camera; and
calculating a contact temperature of the testing sample in the contact zone from the contact emission;
wherein the tribological testing apparatus has a carbon coating on the testing surface of the contact zone, wherein the carbon coating has a first infrared emissivity, wherein the first infrared emissivity is from about 0.8 to about 1.0, wherein the testing sample has a second infrared emissivity, and wherein the first infrared emissivity is within +/−20% of the second infrared emissivity.

16. A method comprising:
applying a carbon coating to a testing surface of a contact zone of a tribological testing apparatus, wherein the carbon coating has a first infrared emissivity, wherein the first infrared emissivity is from about 0.8 to about 1.0;
introducing a lubricant into the contact zone of the tribological testing apparatus, wherein the lubricant has a second infrared emissivity, and wherein the first infrared emissivity is within +/−20% of the second infrared emissivity;
measuring a contact emission of the testing surface of the tribological testing apparatus with an infrared camera, wherein the testing surface is heated by a testing operation of the tribological testing apparatus; and
calculating a contact temperature of the lubricant in the contact zone from the contact emission.

17. The method of claim 16, wherein the carbon coating comprises about 50 wt % to about 100 wt % carbon.

18. The method of claim 16, wherein the infrared camera has an emissivity baseline setting of 0.9 to 1.0.
